(19) United States
(12) Patent Application Publication
(10) Pub. No.: US 2017/0126747 A1
(43) Pub. Date: May 4, 2017

(54) METHODS AND NODES FOR MANAGING SUBSCRIPTION-RELATED INFORMATION OF USERS IN AN IP MULTIMEDIA SUBSYSTEM AS WELL AS A CORRESPONDING SYSTEM AND COMPUTER PROGRAM

(71) Applicant: Telefonaktiebolaget LM Ericsson (Publ), Stockholm (SE)

(72) Inventors: Emiliano MERINO VAZQUEZ, Madrid (ES); Francisca BEJARANO GARCIA, Madrid (ES); Juan Manuel FERNANDEZ GALMES, Getafe (Madrid) (ES); Montse MUÑOZ RODRIGUEZ, Madrid (ES)

(21) Appl. No.: 15/126,924

(22) PCT Filed: Apr. 16, 2014
(86) PCT No.: PCT/EP2014/057729

§ 371 Date: Sep. 16, 2016

(51) Int. Cl. H04L 29/06

(52) U.S. Cl. CPC H04L 65/1016; H04L 65/1069; H04L 65/1046

(57) ABSTRACT

A method and a node for storing subscription-related information and a method carried out in a node including a call session control function or applications server function and a corresponding node. There is a need to diminish signaling load in an IMS and/or shorten signaling time, particularly when updating user profiles in respect to service profiles. This is addressed by a method including the steps of receiving a request message identifying a user; determining whether the received request message comprises an indication of support of a user type associated with the user, the user type indicating that the user shares a certain user profile with other users; and storing for the user an attribute associated with the user type, which attribute is common for a plurality of users all associated with the same user type, if the received request message comprises the indication of support of the user type.

### TECHNICAL FIELD

The present invention relates to a method and a node for storing subscription-related information as well as a method carried out in a node including a call session control function or applications server function and the node including these functions.

### BACKGROUND

A modern telecommunication system may comprise what is named an “Internet Protocol (IP) Multimedia Subsystem”, commonly abbreviated as “IMS” or as “IM Subsystem”. The IMS allows a telecom system to offer multimedia services to user terminals, also referred to as “user equipment” (UE), comprising e.g. voice, video, text, chat and combinations thereof. The architecture and general features of the IMS are generally described in the 3GPP specification TS 23.002, see e.g. version 12.4.0, chapters 3.3a; 4a.7; 5.5.1 and 5.5.2. More specifically, the basic principles, features and flows of IMS are disclosed—at a “stage 2” level—by the 3GPP specification TS 23.228, see e.g. version 12.4.0.

In short, the IMS is logically structured into a so called “core network” layer (implemented by functional entities which are briefly described below), and a so called “service layer”.

Said “service layer” essentially comprises one or more “Application Servers” (AS) arranged to provide a service to the user terminal (UE) of a subscriber connected to the IMS, and/or arranged to mediate in the provision of a service by executing a specific service-based logic, such as to divert an incoming multimedia session in certain circumstances. An AS may receive and/or send (from/to serving entities in the IMS) signaling related to a communication service originated and/or terminated by the user terminal (UE) of a subscriber of the IMS.

Some of the functional entities making up the so called IMS “core network” layer are discussed in the following. The IMS core comprises—among others—two kind of functional entities: the so called “Call Session Control Function” (CSCF), and the so called “Home Subscriber Server” (HSS).

The CSCF can adopt different roles of “Proxy” (P-CSCF), “Interrogating” (I-CSCF) and “Serving” (S-CSCF):

The P-CSCF is the first contact point within the IMS for an UE, and behaves like a “proxy” for the signaling to/from the UE. Since the Session Initiation Protocol (SIP) was envisaged to carry out signaling between the UE and the IMS, the P-CSCF thus behaves like a proxy as defined by the IETF-RFC 3261 (which defines the SIP protocol). Further details of the functionality of a P-CSCF are given in chapter 4.6.1 of the aforementioned 3GPP specification TS 23.228, for example.

The I-CSCF is the contact point within an operator's network for all connections destined to the UE of a user who is a subscriber of that network operator, or the UE of a roaming user currently located within that network operator's service area. Among other functions, the I-CSCF communicates with the HSS to obtain the address of the S CSCF where to forward signaling received in respect to an UE via a P-CSCF (e.g. registration signaling of the UE, or signaling relating to a service terminating in said UE). Further details of the functionality of a I-CSCF are given in chapter 4.6.2 of the aforementioned 3GPP specification TS 23.228, for example.

The S-CSCF performs the session control services for an UE. It maintains a session state according to the (SIP) signaling exchanged with an UE for supporting the services originated and/or terminated by the UE. It can also communicate with Application Server(s) of the IMS “service layer” to handle a service for an UE. Further details of the functionality of a S-CSCF are given in chapter 4.6.3 of the aforementioned 3GPP specification TS 23.228, for example.

The HSS is the master database for storing data for a given user, such as subscription-related information. Said subscription-related information comprises, among other, user profile data of said user, which in turn includes service profile data that govern/control how the services originated and/or terminated by said user are to be controlled within the telecom network (i.e. the so called “service profile” data). The user profile related data is referred, in some implementations, as subscription (data). For example, the FIGS. 10a and 10b disclose a structure of a user profile data—including service profile data—held by a telecommunications system comprising an IP Multimedia Communications Subsystem (IMS). In more detail, the HSS is the entity containing the subscription-related information to support the system nodes actually handling communications, e.g. calls, sessions, etc., with a UE registered for said user. For example, the HSS provides support to the nodes implementing call/session functionalities in order to complete the routing/roaming procedures by solving authentication, authorization, location dependencies, user profile management for service execution (i.e. the so called “service profile” which is associated to a certain user—and included within his “user profile”; e.g. “IMS subscription”), etc.

Further details of the functionality of the HSS are given in chapter 4.1.1.1 of the 3GPP specification TS 23.002, for example.

For attending to the CSCFs and to the ASs, a HSS supports generally two kinds of interfaces: the so called “Cx” interface (HSS⇄CSCF), and the so called “Sh” interface (HSS⇄AS).

The Cx interface is used to send from the HSS to the S-CSCF, assigned to attend signaling messages related to a certain subscriber, the corresponding subscriber data. The data transmitted via the Cx interface include—among other user profile data—the so called “initial Filter criteria” (iFC), which e.g. indicates to the S-CSCF which SIP requests should be proxied to which ASs. Protocol details of the “Cx” interface are defined in the 3GPP TS 29.228, see e.g. version 12.1.0.

The Sh interface is between the HSS and an AS (e.g. a SIP Application Server, or a OSA SCS) and may be used for transferring profile information of a subscriber, such as user service related information or user location information or charging function addresses. Protocol details of the “Sh” interface are defined in the 3GPP TS 29.328, see e.g. version 12.4.0.

In order to specify how to handle different services in the IMS core network entities in respect to an end user, the 3GPP has standardized how communications services are to be handled in the IMS in the 3GPP specification TS 23.218, see e.g. version 12.3.0. In addition, 3GPP has also standardized the procedures for service profile and location management in abovementioned TS 29.228 (IMS Cx interface).

The aforementioned 3GPP TS 29.228 describes how the HSS and S-CSCF must perform service profile handling and S-CSCF assignment for the end users. These procedures usually involve one request message per user provisioned in the HSS, both for updating subscriber data and for location management, which means that many O&M (Operations and Maintenance) tasks initiated by the operator and affecting the profile data of many users (i.e. not of a single user) result in the HSS sending thousands or millions of messages across the network to inform the S-CSCF. The same issue occurs in Sh interface (described in 3GPP TS 29.328): for example, a massive user deregistration results in massive signaling towards the ASs subscribed to the IMS user status. This is a concern for many operators, since there is no standard way to alleviate the signaling, and also to speed up these operations.

When related to iFC (“iFC” stands for “initial Filter Criteria”; it is a part of the service profile related to a user—stored permanently in a HSS and temporarily in the S-CSCF assigned to serve a UE of said user—and comprising, among other, service triggers for routing multimedia communication signaling towards different Application Servers executing and/or mediating in said services), the so-called Shared iFC (SiFC is described in TS 29.228, chapter 6.6) solves part of the problem (changes in triggers do not result in massive signaling over Cx interface). In particular, the so-called Shared iFC (SiFC) dispense with the need of downloading HSS>S-CSCF of all the data making up the iFC's for a certain user whose UE is assigned (e.g. at UE registration) to the S-CSCF. Instead, the HSS stores an identifier per user to a certain iFC and the S-CSCF associates the identifier to the definition of iFC's contents, which are referenced by using common identifiers, so that only downloading of the corresponding identifier (HSS→S-CSCF) suffices.

However, although an extended usage of Shared iFC's clearly tends to diminish signaling load at massive update of user profile data (i.e. references to some pieces of the profile are used, rather than the whole data), it faces the network operator with new issues.

In a network with many S-CSCFs, and since the shared iFC must be defined in all of them, it is hard to keep all nodes consistent since changes are rarely performed simultaneously. Considering multi-vendor scenarios, each S-CSCF may have a different data modelling for these sorts of data.

If the shared iFC has to be accessible over the Sh interface to be consumed by the ASs, the operator must define the same data in all S-CSCFs and the HSSs, which can be very complex to maintain.

In summary, there is no way to have subscriber data and location management data centralized in a single node, such as the HSS, and at the same time avoid massive signaling in the IMS network when it comes to updating the profile of a substantial number of users.

FIGS. 1 and 2 illustrate the problem in more detail. In particular, FIGS. 1 and 2 illustrate examples wherein the service profile of a group of users (in the example one thousand users) is updated in the HSS, e.g. via O&M procedures, and, subsequently, the necessary updates have to be sent from the HSS to the one or more concerned S-CSCFs and ASs. While in the examples of FIGS. 1 and 2 only one user is assigned to one S-CSCF and AS, respectively, it is clear to the skilled person that if several users are assigned to the same S-CSCF, there would still exist the need to send several Push-Profile-Requests (or Push-Notification-Requests), namely one for each user, from the HSS to the S-CSCF (or AS).

Below is the data model example relevant for the Cx interface for a group of users (one thousand in the example).

Public ID 1→sip:+3491000001@telefonica.net, Service Profile Id=X, CN Authorization=Y, mandatory capabilities=Z

Public ID 2→sip:+3491000002@telefonica.net, SP Id=X, CN Auth.=Y, Caps=Z

. . .

Public ID 1000→sip:+3491001000@telefonica.net, SP Id=X, CN Auth.=Y, Caps=Z

The problem arising with respect to these prior-art examples can be detailed as follows:

In step 1 of FIG. 1, a service profile associated to thousands of users is updated, because a new application server for a new service is added, for example. In step 2, the HSS prepares a list of user to be updated. In steps 3-5, Cx Update (Push-Profile-Request, PPR) is sent for each user on the list. In step 6, the operation takes some minutes, since the HSS applies throttling to protect the S-CSCFs from overload. In step 7, a terminating session request is received e.g. for User 1000. Since the profile for User 1000 has not been updated, the request is handled using the old service profile in step 8. Since this profile is obsolete, i.e. it does not include the new service, the request is not handled properly. In steps 9-10, after few more minutes, all service profiles are updated.

FIG. 2 below shows the impacts over the Sh interface of a scenario which is very similar to the one described above.

As a result from the problems discussed above, any common profile change, e.g. Media Profile Id, may result in massive signaling in the network and it may take some time, e.g. several hours in large networks, to be completed. This makes it very difficult for the operator to know when all users have been treated, or even if all the users have been treated.

Accordingly, there is a need to diminish signaling load in an IMS and/or shorten signaling time, particularly when updating user profiles in respect to service profiles of a set of multiple users.

### SUMMARY

Suitable methods, nodes, a system and a computer program are defined in the independent claims. Advantageous embodiments are defined in the dependent claims.

In one embodiment, a method carried out by a subscriber information node for storing subscription-related information of users in an IP Multimedia Subsystem, IMS, is provided. In one step of the method a request message identifying a user is received. Then, it is determined whether the received request message comprises an indication of support of a user type associated with the user. The user type indicates that the user shares a certain user profile with other users. If the received request message comprises the indication of support of the user type, an attribute associated with the user type is stored for the user. The attribute is common for a plurality of users all associated with the same user type. As a result, subscription-related information may be obtained to determine how signaling can be reduced in subsequent procedures, such as updating or de-registration procedures.

In one embodiment, a method carried out by a node including a call session control function or application server function in an IMS comprises the step of generating a request message identifying a user. The request message comprises an indication of support of a user type associated with the user. The user type indicates that the user shares a certain user profile with other users. The method further comprises sending the generated request message to a subscriber information node as well as receiving from said subscriber information node at least one of a profile downloading message and an update profile message. The profile downloading message comprises information on the user type of a user profile for the user and the update profile message comprises information on a user type of user profiles of a plurality of users. As a result, the amount of received signals may be reduced since the messages received comprise information on the user type so that all users associated with the same user type can be treated similarly.

In one embodiment, a subscriber information node for storing subscription-related information of users in an IMS is provided. The node comprises a receiver configured to receive a request message identifying a user as well as a determinator, also referred to as determiner. The determinator is configured to determine whether the received request message comprises an indication of support of a user type associated with the user. The user type indicates that the user shares a certain user profile with other users. The node further comprises a storage configured to store for the user an attribute associated with the user type if the received request message comprises the indication of support of the user type. The attribute is common for a plurality of users all associated with the same user type. As a result, the subscriber information node may obtain subscription-related information to determine how signaling can be reduced in subsequent procedures, such as updating or de-registration procedures.

In one embodiment, a node including a call session control function or application server function in an IMS is provided. The node comprises a generator configured to generate a request message identifying a user. The request message comprises an indication of support of a user type associated with the user. The user type indicates that the user shares a certain user profile with other users. The node further comprises a sender configured to send the generated request message to a subscriber information node and a receiver configured to receive from said subscriber information node a profile downloading message and/or an update profile message. The profile downloading message comprises information on the user type of a user profile for the user and the update profile message comprising information on a user type of user profiles of a plurality of users. As a result, the amount of received signals at the node may be reduced since the messages received comprise information on the user type so that all users associated with the same user type can be treated similarly.

In another embodiment, a system is provided comprising the above-described elements of the subscriber information node, namely the receiver, the determinator, and the storage and the above-described elements of the node including a call session control function or application server function, namely the generator, the sender and the receiver.

In another embodiment, a computer program is provided which includes instructions configured, when executed on a data processor, to cause the data processor to execute the above-described methods.

Further, advantageous embodiments of the invention are disclosed in the dependent claims.

### BRIEF DESCRIPTION OF THE DRAWINGS

FIG. 1 illustrates an exemplary flow diagram to assist the reader in understanding conventional signaling over the Cx interface.

FIG. 2 illustrates and exemplary flow diagram to assist the reader in understanding conventional signaling over the Sh interface.

FIG. 3 illustrates operations of a method for storing subscription-related information according to an embodiment of the invention.

FIG. 4 illustrates operations of another method at a system node according to an embodiment of the invention.

FIG. 5 illustrates an example of the structure of a user profile.

FIG. 6 illustrates an example of the structure of a user profile according to an embodiment of the invention.

FIG. 7 illustrates an exemplary flow diagram for explaining initial registration over the Cx interface according to an embodiment of the present invention.

FIG. 8 illustrates a table with examples of user types.

FIG. 9 illustrates an exemplary flow diagram for explaining initial registration over the Sh interface according to an embodiment of the present invention.

FIGS. 10a and 10b illustrate an example how a user profile can be extended.

FIG. 11 illustrates an exemplary flow diagram for explaining massive update over the Cx interface according to an embodiment of the present invention.

FIG. 12 illustrates an exemplary flow diagram for explaining massive update over the Sh interface according to an embodiment of the present invention.

FIG. 13 illustrates an exemplary flow diagram for explaining massive de-registration according to an embodiment of the present invention.

FIG. 14 illustrates an exemplary structure of the subscriber information node that may be adopted in some embodiments of the invention.

FIG. 15 illustrates an exemplary structure of a system node that may adapted in some embodiments of the invention.

### DESCRIPTION OF THE EMBODIMENTS

Some embodiments of the invention are described with reference to the figures. It is noted that the following description contains examples only and should not be construed as limiting the invention.

In the following similar or same reference signs indicate similar or same elements or operations/steps.

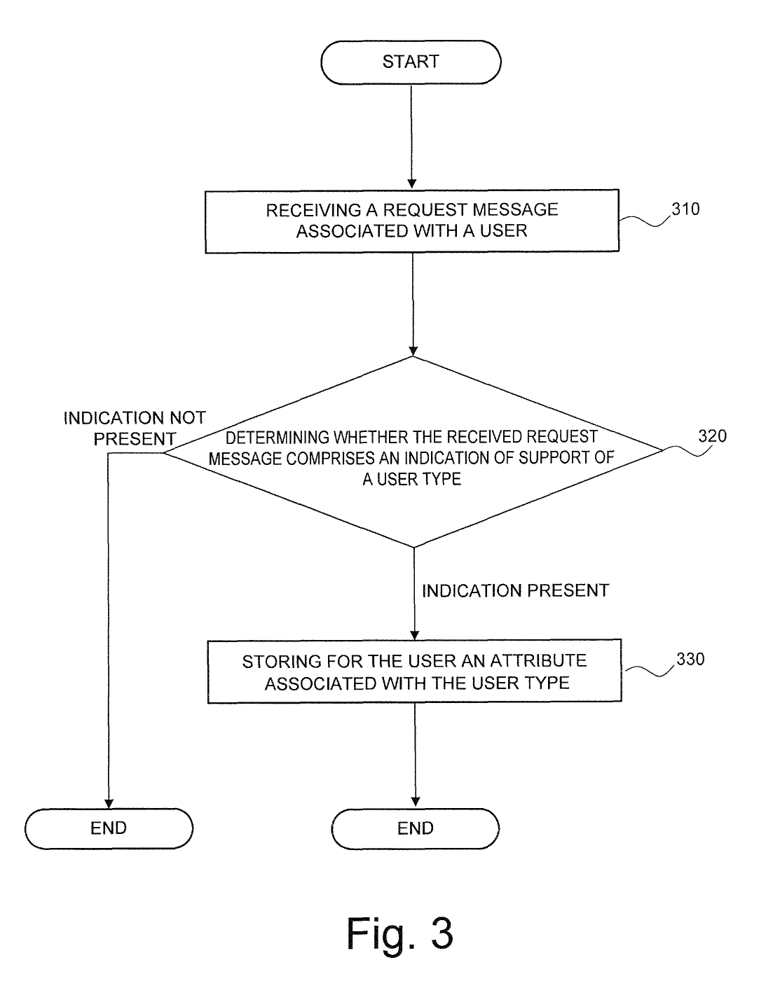

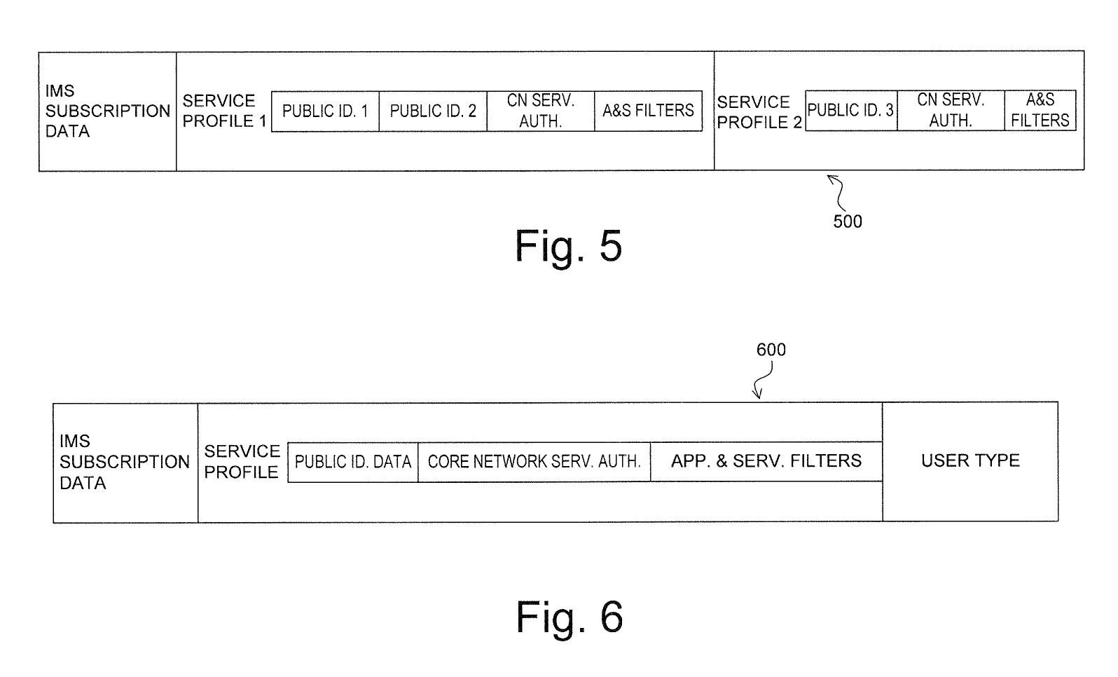

FIG. 3 illustrates a flow chart of a method for storing subscription-related information, e.g. IMS subscription data that may be provided in a user profile or other information in or associate with a user profile, such as the one discussed in detail below with respect to FIGS. 5 and 6. The operations of the method, also referred to as steps in the following, may be carried out by a subscriber information node, such as a Home Subscriber Server (HSS) supporting system nodes. The detailed examples further below explain the functions of the HSS in more detail.

As can be seen in FIG. 3, the method comprises a step 310 in which a request message associated with a user is received. In particular, the request message identifies the user by comprising an identifier, such as a public identifier of the concerned user, that may be provided in a user profile as described in more detail below with respect to FIG. 5.

For example, the request message may be a Server-Assignment-Request (SAR) message over the Cx interface (Cx-SAR message). The Cx-SAR message may be provided as signaling from the S-CSCF to the HSS to notify that a S-CSCF has been assigned to serve further messages intended to be originated and/or terminated by a terminal of a user, for example.

After receiving the request message, e.g. Cx-SAR message, it is determined in step 320 whether the received request message comprises an indication of support of a user type associated with the user. The indication of support may be signaled via AVP (Attribute-Value Pairs) which will be described in more detail below. The user type indicates that the user shares a certain user profile (e.g. in respect to at least service profile) with other users. For example, the user type is data indicating that each and every of the users associated to the same “user type” value share a certain user profile (e.g. at least in respect with the data of said profile that governs the execution of services originated and/or terminated from/to said users), wherein the data can be included in a service profile of a user profile associated with a certain user as shown later with respect to FIG. 6.

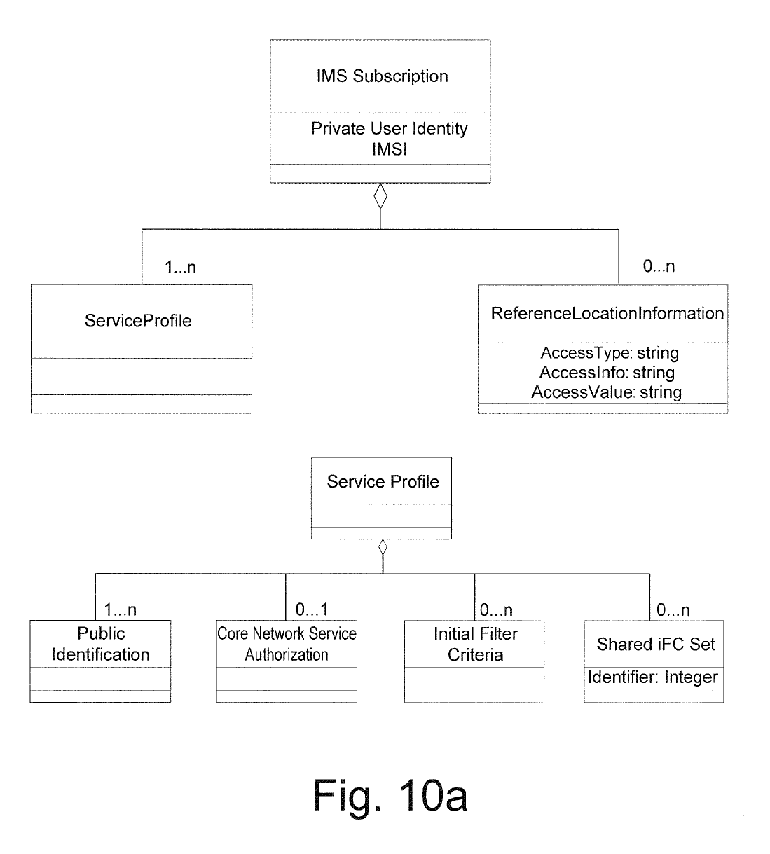

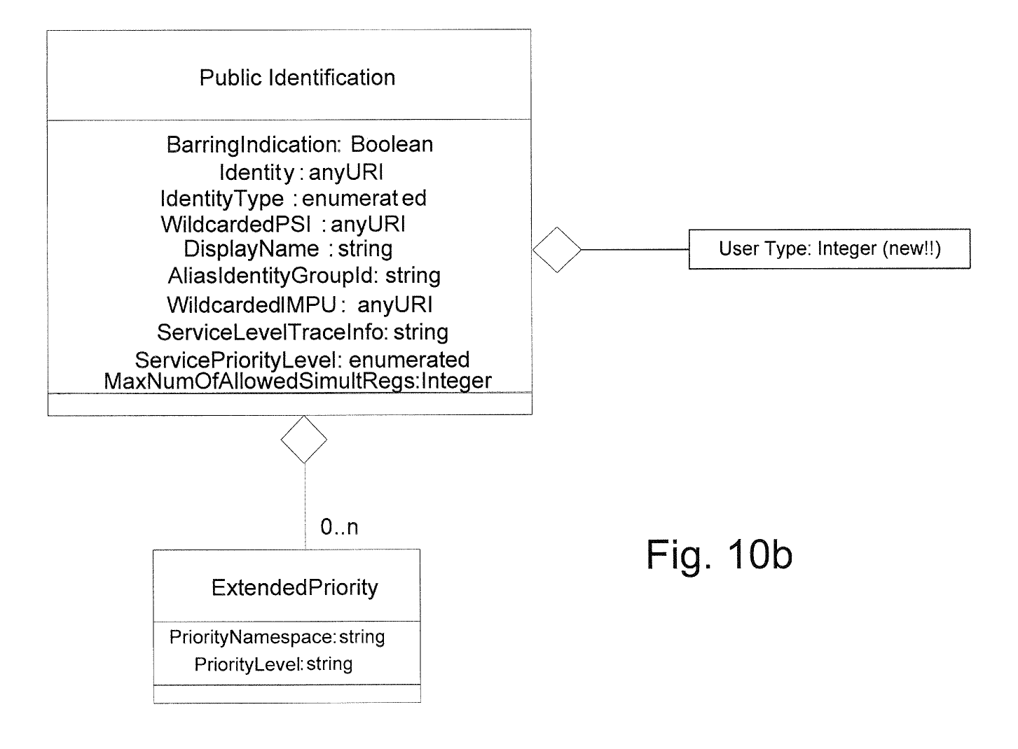

Generally speaking, it can be said that a certain “user type” value indicates that all the users associated to said value share the same user profile data that make up the rules for governing the service execution processing of services originated or intended to be terminated by/on terminals (UE) of said user. In the particular case of IMS—which is described herein in the context of a preferred embodiment—, a certain “user type” value indicates that at least some parts of the user profile of a user are shared (i.e, it is common) with other users that are associated to the same “user type” value; more precisely, that their—so called—“service profile”—is common for all of them. In particular, the foregoing detailed description is given in respect to a preferred embodiment which includes a telecommunications system comprising a IMS, and which establishes a structured user profile (i.e. the so called “IMS subscription” illustrated by FIG. 10a) where the user profile contains a—separate—element called “service profile”. However, the IMS embodiment is given herein just as an illustrating example. Therefore, the expression “sharing a certain user profile with other users” embodies, in the particular case of IMS, sharing at least part of the IMS “service profile” and, generally, sharing with other users the same user profile in respect to data governing their originating and/or terminating service execution processing by the telecommunications system. However, other alternative implementations are possible where the user profile data that govern the processing of originating and/or terminating services is structured and/or defined in other manners. In any of these eventual alternative implementations, and according to embodiments of the present invention, a common “user type” value can be assigned to the profile of a plurality of users; thereby allowing to diminishing signalling between telecommunication nodes when coming to update their profile.

If it is determined in step 320 that an indication is present, i.e. if the received request message comprises an indication of support of a user type, an attribute associated with the user type is stored for the user in step 330; otherwise, if no indication is present, an attribute is not stored and the node operates in conventional fashion.

In more detail, an attribute, for example a value indicating a user type, is stored, i.e. registered, in the subscriber information node, if an indication is present. The attribute is common for a plurality of users all associated with the same user type and may be provisioned together with the corresponding service or user profile. For example, the attribute may be the user type itself, and particularly its value for the concerned user, and is preferably a part of the service profile of the user. For example, by using as a searching key an identifier of the user, e.g. a public or private identifier of the user, the subscriber information node can identify, both, the service profile associated to the user as well as the user type that corresponds to the service profile. Users associated with the same user type belong to the same category/profile group and are associated to the same user type value, e.g. their service profile comprises the same value at the same position of the service profile structure.

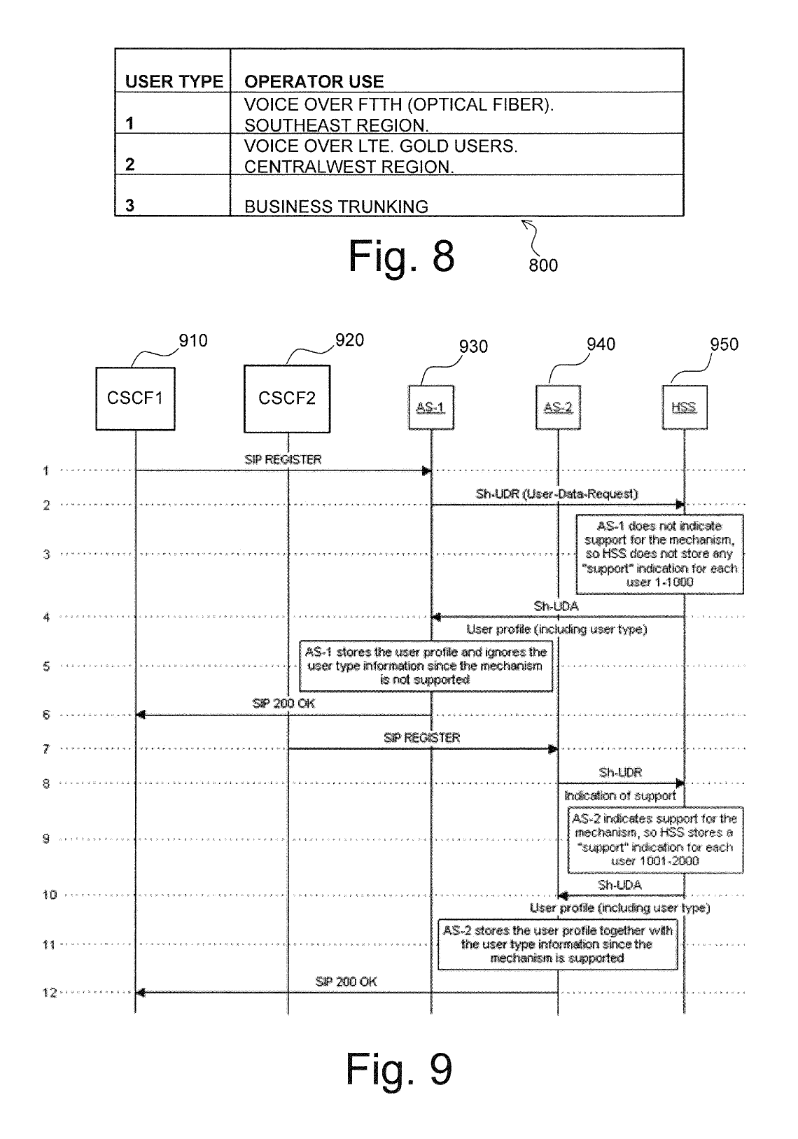

After storing the attribute associated with the user type the subscriber information node may send to a second node including a Call Session Control Function (CSCF) or Application Server (AS) function a profile downloading message comprising information on the user type, e.g. the user type itself or the user profile including the user type, of a user profile stored at the subscriber information node for the user. The information element user type or any associated attribute can take different values, such as an integer between 1 and 65,535, wherein a certain value relates one-to-one to a certain service profile (see FIG. 8 explained in detail below). For example, all users having associated, e.g. to their public identifiers (see FIGS. 5, 6 and 10), the same user type, e.g. the user type with a value of “125”, share the same service profile data contents.

The profile downloading message may be a Server-Assignment-Answer (SAA) message sent over the Cx interface (Cx-SAA message) from the HSS to the S-CSCF to download the service profile corresponding to the user. In this respect, the Cx-SAA sets up data in the S-CSCF by including the user type in the user profile in the message, for example.

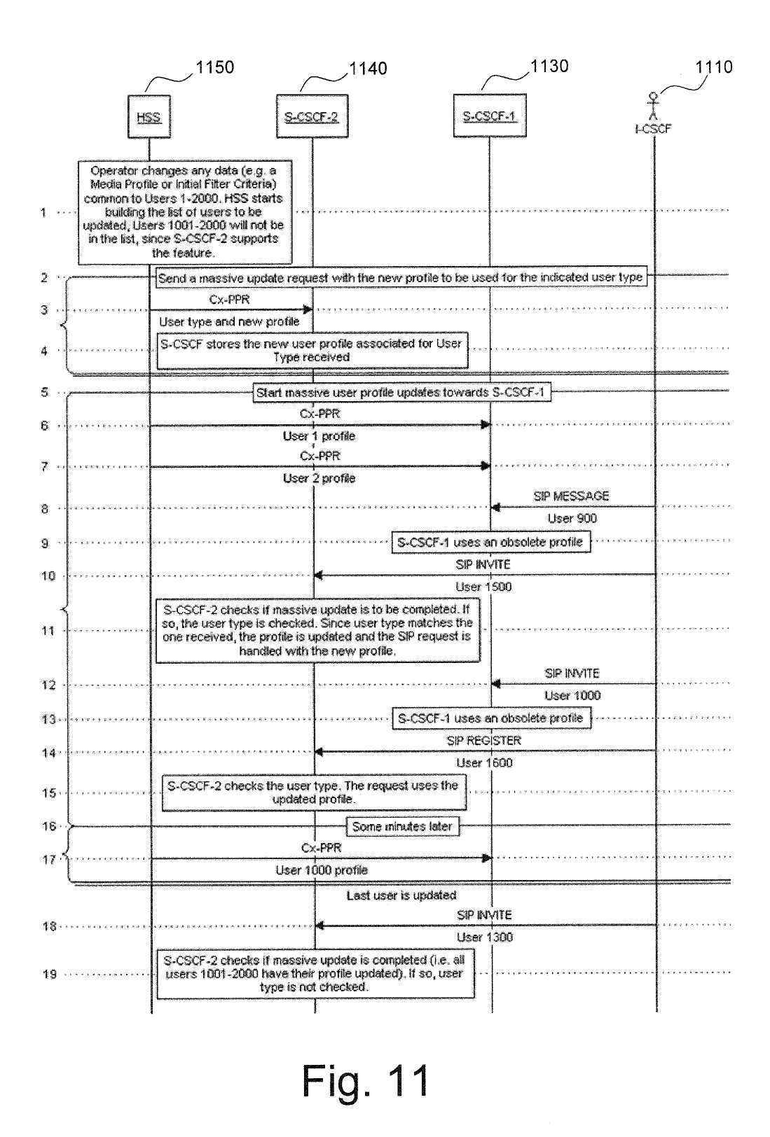

In a similar way, as discussed above with respect to the profile downloading message, an update profile message comprising information on the user type, e.g. the user type itself or the user profile including the user type, stored at the subscriber information node, e.g. HSS, may be sent, to request to update at the second node including the CSCF or AS function the user profiles of the plurality of users associated with this user type. In this case, the update profile message may be a Push-Profile-Request (PPR) message over the Cx interface (Cx-PPR message). The Cx-PPR message may similarly include the user type as well as a new profile, which is described in more detail with respect to FIG. 11.

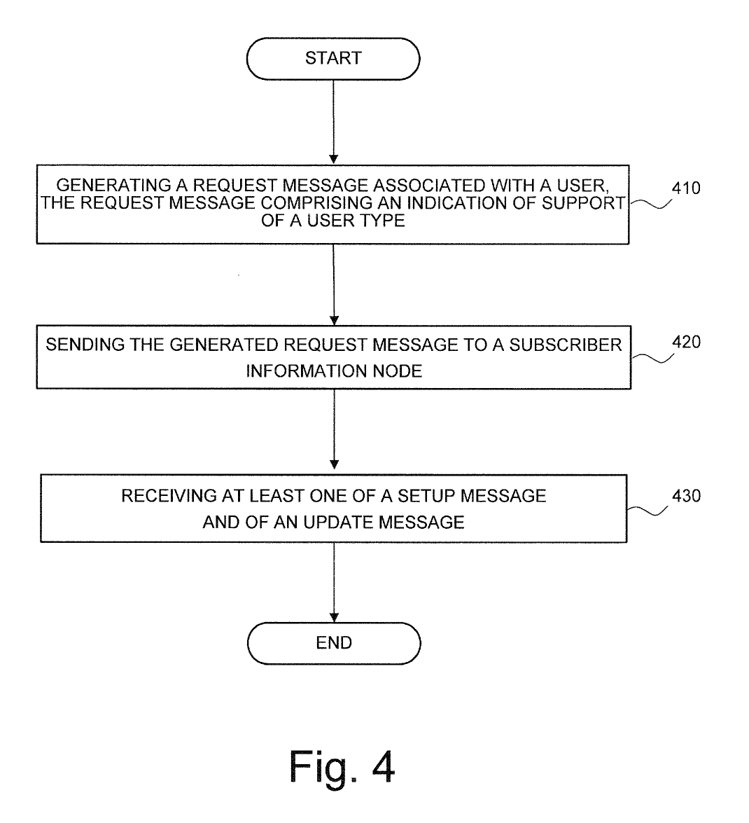

Next, operations carried out in the above mentioned second node including the CSCF or AS function are discussed with respect to FIG. 4. For example, the second node, which is also referred to as system node, may be a node of the IMS including the CSCF and may communicate with the HSS over the Cx interface or may be a node including an application server and may communicate with the HSS over the Sh interface.

As shown in step 410, a request message identifying a user is generated. The request message may be the request message which is obtained by the subscriber information node, as explained above with respect to FIG. 3. Thus, this request message may be a Cx-SAR message. The request message comprises an indication of support of a user type associated with a user, as mentioned above with respect to FIG. 3. Generation of the message may be done by setting a bit for indicating the support of a user type in a field of a bit mask included in the request message. As mentioned above, the user type indicates that the user shares a certain user profile with other users.

The generated request message is then sent to the subscriber information node, as shown in step 420 and received by the subscriber information node as explained before with respect to step 310 in FIG. 3.

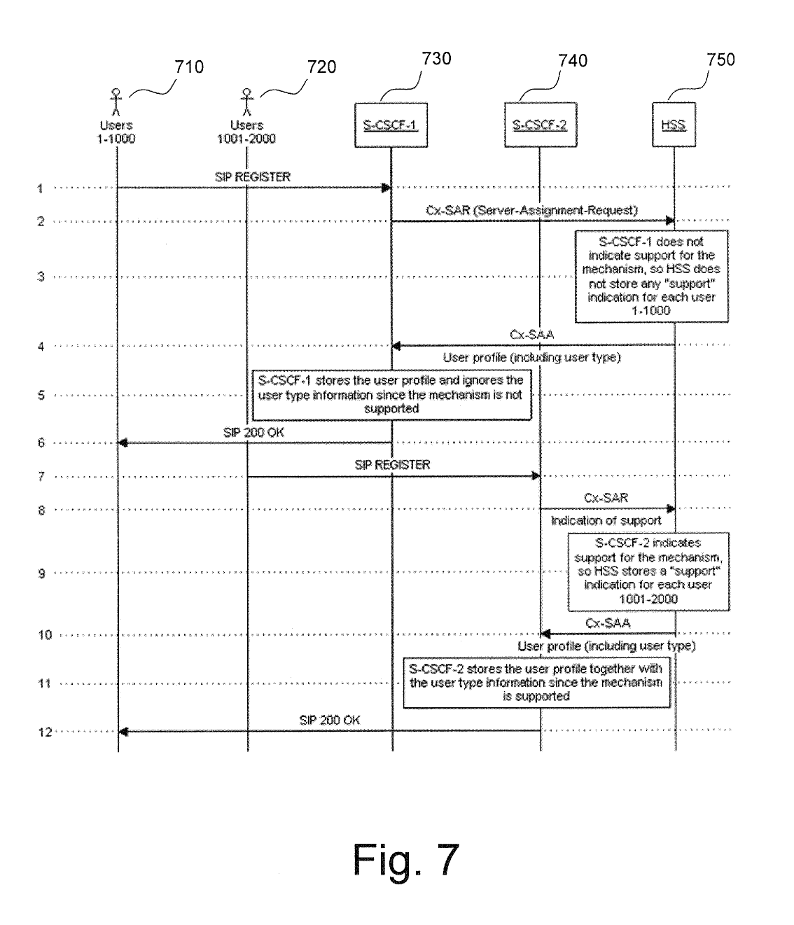

In the next step 430 of FIG. 4, at least one of a profile downloading message comprising information on the user type of a user profile for the user and of an update profile message comprising information on a user type of user profiles of a plurality of users is received from the subscriber information node. These messages were explained in detail above and the information on a user type included in these messages may be stored in the system node. In particular, the information is stored in the system node (also previously called second node), if the generated request message indicates that the user type is supported. In the same way, it is also possible to store the user profile itself which includes information on the user type, such as the user type value. Details about the different messages and information on the user type will be provided with respect to FIGS. 7, 9, 11 and 12.

In one example, the profile downloading message comprises, as the information on the user type, a user profile including the user type of the user associated with the request message. In another example, the update profile message comprises, as the information on the user type, a new user profile and a user type for all users associated with the user type. In a simple example the information on the user type is the above mentioned attribute. As mentioned above, the user profile may be a user profile of IMS subscription data including a field in a predetermined bit pattern indicating the user type.

In response to receiving the update profile message, user profiles stored at the system node may be updated, namely the user profiles of the plurality of users associated with the user type informed by the update profile message may be updated.

According to above discussed aspects, the HSS stores an attribute indicating, e.g. user type, which will be common for all users of the same category/profile (for example, users subscribed to a certain service profile related to a certain commercial product, such as “Movistar Fusion 4G” for users living in the south-east of Spain). This attribute is then preferably provisioned together with the corresponding service profile of the concerned user and identifiers at the service profile level. At reception of an initial registration from a UE, providing from the HSS the information on the user type to the S-CSCF within the user profile at Cx-SAA command is performed.

At reception of an update profile message by the S-CSCF from the HSS (e.g. Cx DIAMETER message PPR from the HSS to the S-CSCF, including the user type, optionally the range of identities affected and the new profile for such users), the S-CSCF replaces the old user profile by the new one provided by the HSS for all users having the same user type.

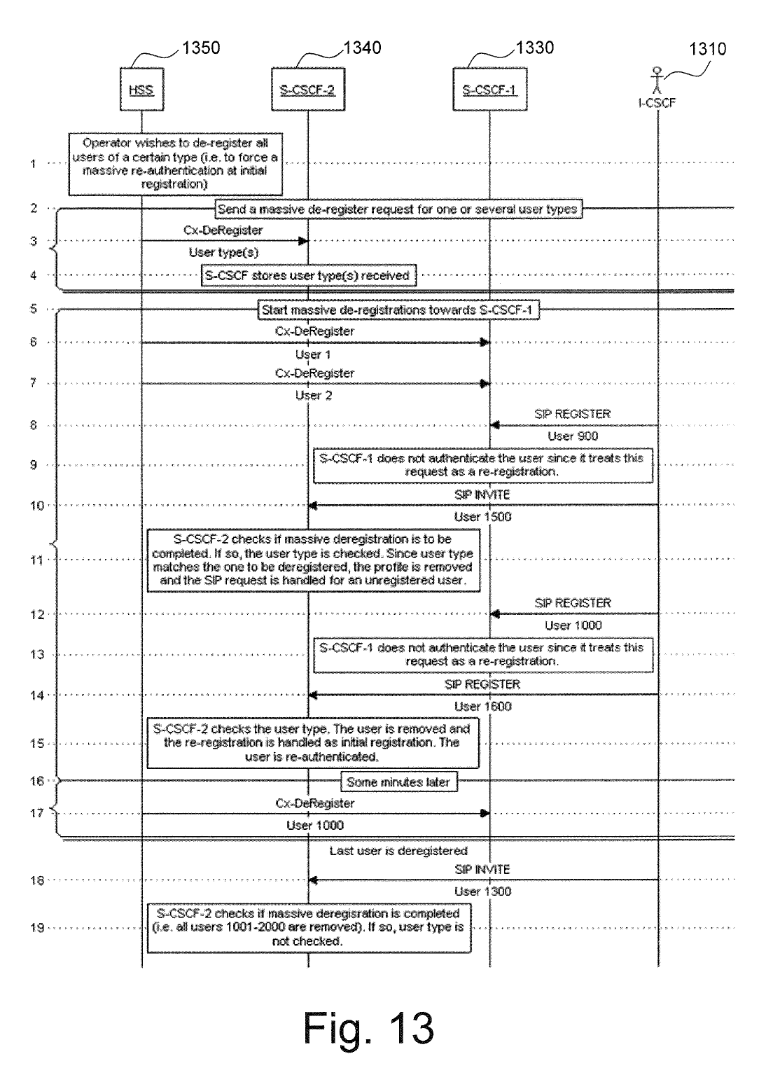

Instead of updating user profiles, at reception of a Cx-deregister request by the S-CSCF from the HSS (e.g. Cx DIAMETER message RTR including the user type and/or a range of identities affected), the users are deregistered, which will be described later with respect to FIG. 13.

As a result, methods to diminish signaling load in an IMS when updating service profiles of a set of users or deregistering users can be provided. In particular, instead of sending, e.g. from HSS to S-CSCF via the Cx interface, for each and every user affected one signal, a single signal per S-CSCF is sent, which may include the updated profile data and specifically a common identifier usable to identify by the S-CSCF all the affected user. The common identifier that achieves identifying the users affected by the update of the service profile is the above mentioned user type. Therefore, by addressing an update in respect to user type rather than to individual identifiers, a single signal, e.g. from the HSS to the S-CSCF, can be used to accomplish the modification of the service profile of a huge number of users.

Further details regarding initial registration, updates and deregistration are now discussed with respect to the remaining figures.

FIG. 5 is taken from Annex D of 3GPP TS 29.228 and includes the structure of the service profile of a user as part of the so-called user profile sent over the Cx interface. It can be seen that each Service Profile (SP) contains a list of IMS Public Identities with the associated Media Profile ID (CN Serv. Auth.) and the Initial Filter Criteria (AS filters). In more detail, the user profile 500 shows actually two service profiles, a service profile 1 and a service profile 2. As can be seen in the service profile 1, the same user can have two public identifiers, Public Id. 1 and Public Id. 2 in the service profile 1 and a third public Id. 3 in service profile 2. The public Id may be a telephone number or SIP URL. For details, it is referred to the above identified Annex.

In FIG. 6, it is depicted how the user profile 600 may comprise the information on the user type, namely a new field dedicated to the user type. By including this new field a value may be provided in the user profile indicating the group/category to which the specific user belongs to. As mentioned above, a value for a user type may be e.g. “125” and users with the same value in their user profiles are users of the same group/category.

It is noted that the service profile in IMS comprises data values that are utilized by the S-CSCF and/or AS assigned to a certain user to govern how services originated and/or terminated by the terminal of a user are to be held. In IMS, the service profile is associated to a public identifier of the user, e.g. the MSISDN or SIP-URL that one can utilize to call a user. In the case of IMS, a user can have one or more public identifiers, as explained above, but each one of these public identifiers is associated to only one service profile. Therefore, if an IMS user originates a call from his terminal, its originating call will be treated by its assigned S-CSCF and/or AS, according to the service profile associated to the public identifier indicated by the terminal in the originating party identification information of the call. Similarly, if an IMS user receives a call, the call will be treated by its assigned S-CSCF and/or AS according to the service profile associated to the public identifier indicated by the calling party in respect to the terminating party in the identification information of the call. In other words, if “A” calls to “B”: the call will be treated by A's servers according to A's profile (i.e. as related to A's public identifier indicated by “A”), and the call will be treated by B's servers according to B's profile (i.e. as related to the B's public identifier indicated by “A” on his call).

Several flow diagrams are presented in the following providing detailed examples of managing subscription-related information at nodes of the IMS. For the sake of illustrating features of compatibility, S-CSCF-2/AS-2 are assumed to support the novel features of the invention, whereas it is assumed that S-CSCF-1/AS-1 do not support them. For simplicity, P-CSCFs and I-CSCFs that might intervene in some of the signaling flows of the following figures are not illustrated.

FIGS. 7 and 9 show exemplary flow diagrams of an initial registration where the HSS 750, 950 provides the user type (new data in profile) to S-CSCFs/ASs 730, 740, 930, 940 and stores/remembers per user which S-CSCFs/ASs support the feature. This information may then be used later. Those S-CSCFs/ASs 730, 930 not supporting the feature will handle the profile received as normal (i.e. the user type will be ignored).

In steps 1-2, users 1-1000 (see reference sign 710) perform an initial registration each (note that the figure shows only one REGISTER request, but it is assumed that there are a thousand REGISTER requests, for each user one). S-CSCF-1 730 requests for the user profile. Since S-CSCF-1 does not support the mechanism, it does not indicate anything in the Cx-Put/Pull (Cx-SAR, Server-Assignment-Request) which is a request message.

Part of step 3 is the above-mentioned determining step which may comprise checking whether a bit for indicating support of a user type is set, e.g. as mark or flag, in a field of a bitmask included in the request message. In this example, the HSS stores the user's state as registered, since the S-CSCF did not indicate support for the mechanism, no mark/flag is associated to the user, i.e. the user requires an individual Cx-Update (Cx-PPR, Push-Profile-Request) or individual Cx-DeRegister (Cx-RTR).

In step 4, the HSS 750 returns the user profile in the Cx-SAA message (profile downloading message). Regardless of the S-CSCF support, the new information element “user type” is also included as part of the profile.

Note that a proposal for the User Type IE (Information Element in the XML schema containing the profile) could be an integer so that the operator can choose which values to assign. User type examples are provided in FIG. 8 including user types 1, 2, and 3 indicating different operator uses, such as “Voice over FTTH (optical fiber). SouthEast Region.”, “Voice over LTE. Gold users. CentralWest Region” and “Business Trunking”, respectively.

In steps 5-6, S-CSCF-1 730 stores the user profile. Since the user type IE is not known, it is ignored and the registration is accepted.

In step 7, users 1001-2000 (see reference sign 720) register in the network. For each registration received in step 8, S-CSCF-2 740 requests for the user profile indicating the support for the mechanism. This can be done by using the Feature-List AVP (see table 7.1.1 in 3GPP TS 29.229), with a new bit defined for this feature (e.g. batch procedures). In step 9, HSS 750 stores the user's state as registered, e.g. including the attribute, together with a “massive updates” indication. That is, the user does not require an individual Cx-PPR towards this S-CSCF-2 740 when his profile (e.g. service profile) is updated in the HSS 750 (see FIG. 11). The S-CSCF-2 740 is put in the “massive update” list.

In step 10, HSS 750 returns the user profile. Regardless of the S-CSCF support, the user type is also included as part of the profile. Further, in step 11, S-CSCF-2 740 stores the user profile (which contains the public and private identities) and associates it to the user type received. At this point, S-CSCF-2 740 will know the “user type” for each of the identities received (see in FIGS. 10a and 10b the addition in respect to the data defined in 3GPP TS 29.228, Annex B.2.1). Finally, in step 12, the registration is accepted.

FIG. 9 shows the initial registration procedure over Sh interface and is similar to the procedure over the Cx interface described above. It should be noted that in FIG. 9, the SIP Register is sent from the CSCF to the AS. In particular, in step 1, the SIP Register is sent from the CSCF1 910 to the AS-1 930 which does not indicate support of a user type and in step 7 the SIP Register is sent from the CSCF2 920 to the AS-2 940. Thus, the request message, here User-Data-Request (Sh-UDR), is sent from AS-1/AS-2 to the HSS 950. Details can be taken from FIG. 9 which is self-explanatory.

FIGS. 10a and 10b show details regarding the user profile. As mentioned above, FIG. 10a is explained in Annex B.2.1 of abovementioned 3GPP TS 29.228, e.g. version 12.1.0. FIG. 10b shows details about the Public Identification class, in particular how new data regarding the user type is included in in this class. In this example a user type field is added in the Public Identification class.

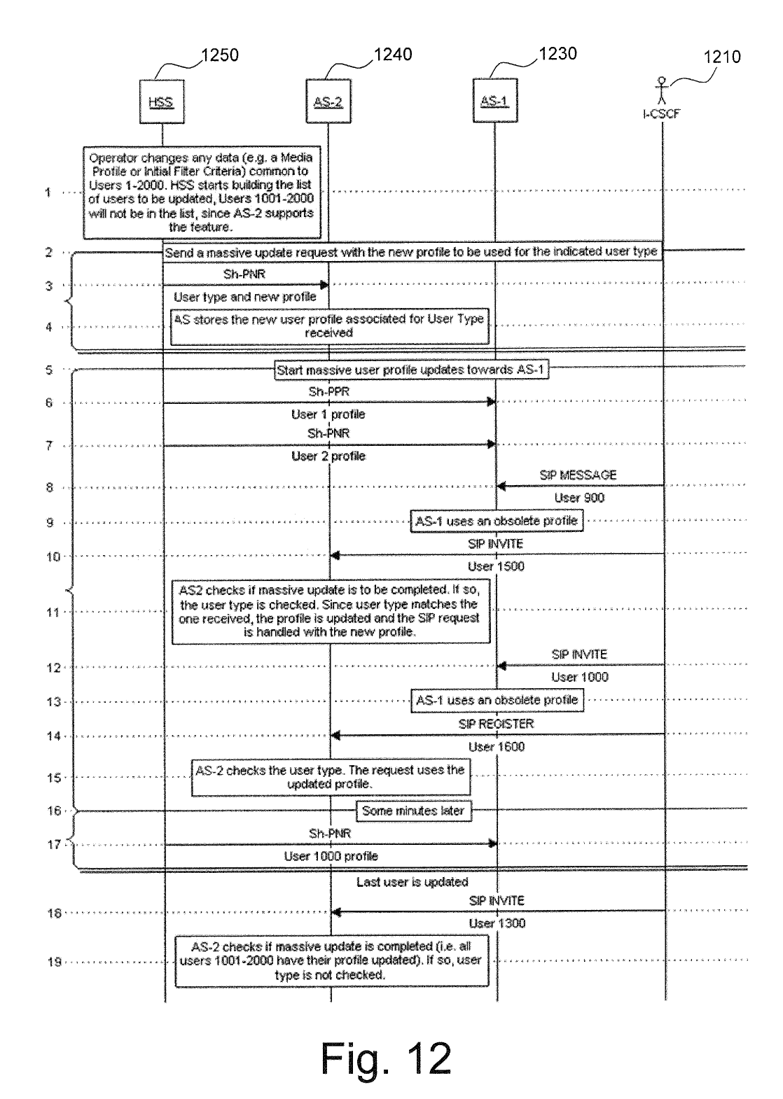

FIGS. 11 and 12 depict exemplary scenarios for the Cx and Sh interfaces, respectively, where a common iFC associated to many users is updated. The HSS 1150/1250 will inform the S-CSCFs and the ASs subscribed to those data about the new value, if they support the feature. This is done with a single diameter command, so that all users are updated at once.

In step 1 of FIG. 11, the operator performs one or several provisioning orders in HSS 1150, e.g. service data change, authorization data change, etc., affecting Users 1-2000. HSS 1150 starts building a list of identities to be updated. To build this list, the users with the “massive update” indication are skipped, since they do not require a Cx-PPR.

In more detail, a user is added to the list if the previously received request message associated with the user (see discussion of FIGS. 7 and 9, in particular step 2) did not comprise an indication of support of a “user type”. For example, a user is added by adding its identifier to the list. The users on this list are thus users for which an individual update profile message has to be sent. In addition, the HSS 1150 fetches the list of S-CSCFs supporting the mechanism, here S-CSCF-2 1140. All this information was stored at initial registration (see FIG. 7).

In steps 2-4, HSS 1150 sends a single Cx-Update towards S-CSCF-2, i.e. in respect to users 1001 to 2000 which are not on the list. For example, the update request message of step 3 (Cx Push-Profile-Request, Cx-PPR) comprising the new info “User Type” IE, instructs the S-CSCF that said request is intended to update in the receiver S-CSCF the service profile for all users of the user type included (i.e. as stated by the value of the “User Type” IE received in the message), and, thus, prompts the S-CSCF to update the corresponding service profiles of the plurality of users associated with (i.e. matching with) the received “User Type” value. The message of step 3 preferably comprises the (i.e. updated) service profile data that is to be assigned to the plurality of users held by the receiver S-CSCF whose “User Type” matches with the “User Type” indicated within the message of step 3. The message of the step 3 can omit including any specific user identifier (i.e. information elements, IE, carrying, either, a Private User Identity and/or a Public User Identity). Therefore, the lack of a specific user identifier in the request (Private User Identity IE), together with the User Type IE, instructs the S-CSCF that the request is intended for all users of the type included. However, for compatibility reasons in respect to Diameter protocol stacks, said message can comprise any private and/or public of any of the affected users. In any case, the presence of the new info “User Type”, instructs the S-CSCF that the request is intended for all users of the type included. For example, the lack of a specific user identifier in the request (e.g. a Private User Identity 1E) together with the User Type IE instructs the S-CSCF that the request is intended for all users of the type included. The new data/profile may also be sent so that the S-CSCF-2 1140 updates each user profile with the new data. In other words, a single update profile message (e.g. FIG. 11, flow 3) is sent to a second node including a call session control function (S-CSCF), wherein the message comprises at least information on the user type stored at the subscriber information node, i.e. HSS, to request to update at the second node 1140 the user profiles of the plurality of users associated with this user type. It is noted that the novel “user type” information element (IE) can take the form of a specific AVP, e.g. User-Type, in the Cx-Update message (e.g. DIAMETER message “Push Profile Request”, PPR, which is discussed in more detail below).

Thus, according to this example, the S-CSCF-2 1140 starts the “massive update” procedure internally for the profile data of all the concerned users held by said S-CSCF-2 which match the “User-Type” received.

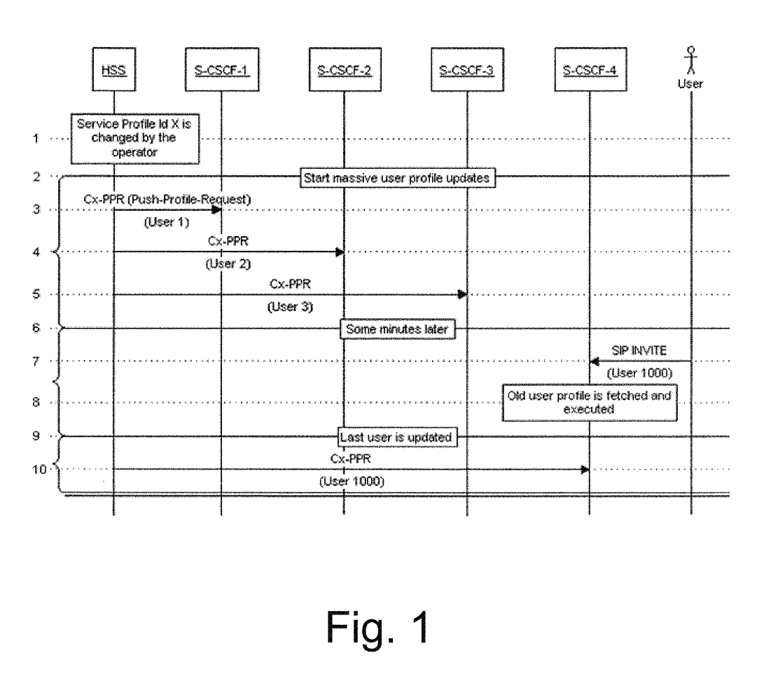

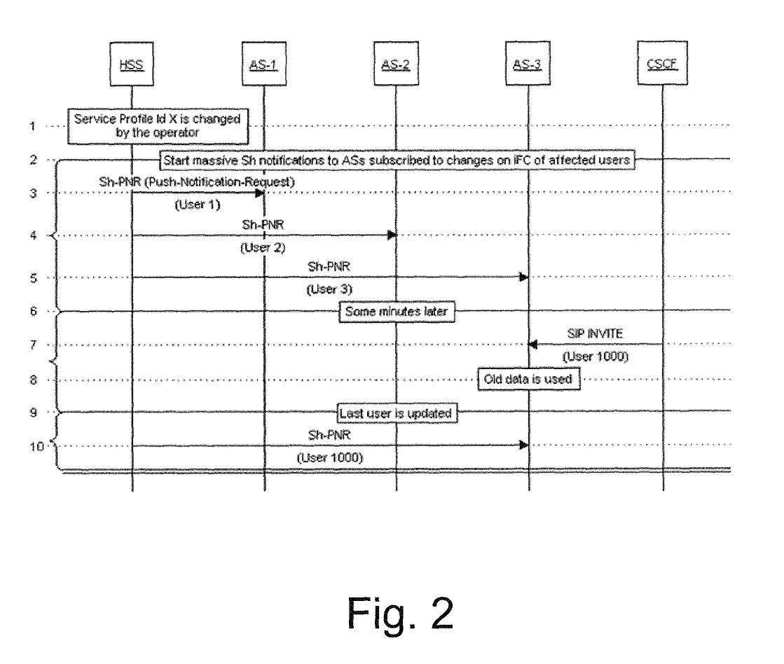

In parallel or subsequently, the HSS 1150 starts in steps 5-9 sending individual Cx-PPRs for users 1 to 1000, since they do not have the “massive update” flag set. Here, a similar scenario as shown in FIG. 1 occurs, namely an obsolete profile is fetched for User 900, since the updating process is still ongoing and has not reached updating the profile of User 900. Accordingly, individual update request messages are send for each user on the list to the node including a call session control function to update a user profile of each of the users on the list individually.

In steps 10-11, upon reception of a terminating request from the I-CSCF 1110, the S-CSCF-2 1140 fetches the profile for the destination (User 1500). The user type stored as part of the profile is checked against the user type to be updated. Since they match, the S-CSCF-2 replaces the stored profile by the one received previously so that the updated profile is utilized to handle the request.

Note that another choice can be that the S-CSCF only stores the user type per user and only a common instance of the profile associated to the user type, i.e. the users are linked to this instance. This way, the old instance of the user type is replaced by the new instance received over Cx so that all users affected are then immediately linked to the new data.

While the individual PPRs are ongoing, more obsolete profiles are fetched by the S-CSCF-1 1130 in steps 12-13.

In steps 14-15, a re-registration is received for User 1600. Since the user type stored in the profile matches the one to be updated, the S-CSCF-2 replaces the profile and continues with the REGISTER request handling.

Finally, in steps 16-19, after a while, the procedure is completed by the HSS 1150 and the S-CSCF.

FIG. 12 shows the “massive update” procedure for the Sh interface, which is very similar to the procedure over the Cx interface described above. Instead of S-CSCFs ASs are involved. In particular, as shown, signaling takes place between HSS 1250, AS-2 1240, AS-1 1230 and I-CSCF 1210. It should be noted that in FIG. 12, instead Cx-PPR messages, i.e. the update profile messages or individual update request messages, are Sh-PNR messages (Push-Notification-Request, PNR). Details may be taken from FIG. 12 which is self-explanatory, in particular in light of the explanation of FIGS. 7, 9 and 11.

FIG. 13 shows an exemplary embodiment of a massive de-registration where the HSS 1350 sends a single Cx-RTR to terminate the registration of a certain type of users.

In step 1 of FIG. 13, the operator wishes a re-authentication at initial registration, e.g. under a suspect of fraud. HSS 1350 starts building a list of identities to be de-registered. To build this list, the users with the “massive update” flag set are skipped, since they do not require a Cx-RTR. In addition, the HSS 1350 fetches the list of S-CSCFs supporting the mechanism. All this information was stored at initial registration (see FIG. 7) and the lists may be created as discussed with respect to step 1 of FIG. 11 or already prepared list, e.g. for massive update, may be used.

In steps 2-4, the HSS 1350 sends a single Cx-DeRegister towards S-CSCF-2 1340. The lack of a specific user in the request (Private User Identity 1E) together with the User Type IE instructs the S-CSCF that the request is intended for all users of the type included. Accordingly, a single de-register message, e.g. Cx-DeRegister message, may be sent to the S-CSCF-2 1340, which is a system node including a call session control function. The de-register message comprises information on at least one user type stored at the subscriber information node, e.g. HSS, to request to de-register at the S-CSCF-2 1340 the users associated with this user type. Deregistration works similarly over the Sh interface where the node to which the de-register message is sent includes an application server function.

In parallel or subsequently, HSS 1350 starts in steps 5-7 to send individual Cx-RTRs for users 1-1000, since they do not have the “massive update” flag set. That is, de-registering the users on the list individually is carried out by sending individual de-register request messages for each user on the list to at least one system node including a call session control function, in the example of FIG. 13 the S-CSCF-1 1330.

In steps 8 and 9, a similar scenario as described in FIG. 1 occurs (User 900 is not authenticated by S-CSCF-1 since it has not been de-registered yet).

Upon reception of a terminating request, the S-CSCF-2 1340 fetches in steps 10 and 11 the profile for the destination from the I-CSCF 1310 (User 1500). The user type stored as part of the profile is checked against the user type to be de-registered. Since they match, the S-CSCF-2 1340 de-registers the user and handles the request for unregistered user.

In steps 12 and 13, while the individual PPRs are ongoing, more users are not re-authenticated. Then, a re-registration is received for User 1600 in steps 14 and 15, and since the user type stored in the profile matches the one to be de-registered, the S-CSCF de-registers the user and continues with the REGISTER request handling as an initial registration, i.e. the user is authenticated.

Finally, after a while, in steps 16-19, the procedure is completed by the HSS and the S-CSCF.

In the following the impact on Cx diameter commands (ABNF) are discussed, wherein this section depicts the modifications required in certain Cx commands to accommodate the discussed features.

Push-Profile-Request (PPR)
< Push-Profile-Request > ::= < Diameter Header: 305, REQ, PXY,
16777216 >

< Session-Id >
{ Vendor-Specific-Application-Id }
{ Auth-Session-State }
{ Origin-Host }
{ Origin-Realm }
{ Destination-Host }
{ Destination-Realm }
{ User-Name }
*[ Supported-Features ]
[User-Type]
[ User-Data ]
[ Charging-Information ]
[Wildcarded-Identity]
[ SIP-Auth-Data-Item ]
*[ AVP ]
*[ Proxy-Info ]
*[ Route-Record ]

The User-Data AVP is extended to include the user type information element as described, whereas the Wildcarded-ldentity AVP is reused from other DIAMETER commands, as described in 3GPP TS 29.228, to optionally indicate a regular expression which restricts the user type affected by the massive update.

The User-Type AVP is new, and contains an integer to indicate the type of user affected. The simple presence of this AVP will instruct the S-CSCF to perform a batch/massive update for users affected. Since this is a request affecting more than user, the User-Name AVP is not applicable, but it is still mandatory in the diameter command (for backward compatibility reasons), so it may contain any user. Note that S-CSCF application layer, upon reception of User-Type AVP, will not take into account the User-Name AVP.

Server-Assignment-Request (SAR)
<Server-Assignment-Answer> ::= < Diameter Header: 301, PXY,
16777216 >

< Session-Id >
{ Vendor-Specific-Application-Id }
[ Result-Code ]
[ Experimental-Result ]
{ Auth-Session-State }
{ Origin-Host }
{ Origin-Realm }
[ User-Name ]
*[ Supported-Features ]
[ User-Data ]
[ Charging-Information ]
[ Associated-Identities ]
[ Loose-Route-Indication ]
*[ SCSCF-Restoration-Info ]
[ Associated-Registered-Identities ]
[ Server-Name ]
[ Wildcarded-Public-Identity ]
[ Priviledged-Sender-Indication ]
*[ AVP ]
*[ Failed-AVP ]
*[ Proxy-Info ]
*[ Route-Record ]

The User-Data AVP is extended to include the user type information element as described. The S-CSCF will store this information at registration and associate it to the user identity and its profile.

Registration-Termination-Request (RTR)
<Registration-Termination-Request>::=< Diameter Header: 304, REQ,
PXY, 16777216 >

< Session-Id >
{ Vendor-Specific-Application-Id }
{ Auth-Session-State }
{ Origin-Host }
{ Origin-Realm }
{ Destination-Host }
{ Destination-Realm }
{ User-Name }
[ Associated-Identities ]
*[ Supported-Features ]
*[ Public-Identity ]
{ Deregistration-Reason }
[ User-Type ]
[ Charging-Information ]
[Wildcarded-Identity]
*[ AVP ]
*[ Proxy-Info ]
*[ Route-Record ]

The Wildcarded-ldentity AVP is reused from other diameter commands, as described in 3GPP TS 29.228, to optionally indicate a regular expression which restrict the user type affected by the massive deregistration.

The User-Type AVP is new, and contains an integer to indicate the type of user affected. The simple presence of this AVP will instruct the S-CSCF to perform a batch/massive deregistration for users affected. Since this is a request affecting more than user, the User-Name AVP is not applicable, but it is still mandatory in the diameter command (for backward compatibility reasons), so it may contain any user. Note that S-CSCF application layer, upon reception of User-Type AVP, will not take into account the User-Name AVP.

Impact on XML Schema (User-Data AVP)

The XML sheet containing the profile is extended so that User-Type is included as shown below (only the relevant part of XML is shown for simplicity).

<xs:complexType name=“tServiceProfileExtension”>
<xs:sequence>
<xs:element name=“SharedIFCSetID” type=“tSharedIFCSetID”
minOccurs=“0”
maxOccurs=“unbounded”/>
<xs:element name=“Extension” type=“tServiceProfileExtension2”
minOccurs=“0”/></xs:sequence>
</xs:complexType>
<xs:complexType name=“tServiceProfileExtension2”>
<xs:sequence>
<xs:element name=“UserType” type=“tUserType” minOccurs=“0”
maxOccurs=“1”/>
<xs:element name=“Extension” type=“ tExtension”
minOccurs=“0”/></xs:sequence>
</xs:complexType>
<xs:simpleType name=“ tUserType ” final=“list restriction”>
<xs:restriction base=“xs:int”>
<xs:minInclusive value=“1”/>
<xs:maxInclusive value=“65535”/>
</xs:restriction>
</xs:simpleType>

New Cx Feature (Supported-Features AVP)

The feature list is extended with the new feature to be advertised by the S-CSCF. A new bit (3) in the bitmask is used for this purpose.

| | | | |
|---|---|---|---|
| 3 | Batch_proc | O | Batch procedures indication |
| | | | This feature is applicable for the SAR/SAA, |
| | | | PPR/PPA and RTR/RTA command pairs. |
| | | | If the S-CSCF supports the feature, the HSS |
| | | | may send a single request (PPR/RTR) to |
| | | | perform massive updates or de-registrations. |

In the following the impact on Sh diameter commands (ABNF) is discussed, wherein this section depicts the modifications required in certain Sh commands to accommodate the discussed features.

User-Data-Answer (UDA)
< User-Data-Answer > ::=< Diameter Header: 306, PXY, 16777217 >

< Session-Id >
{ Vendor-Specific-Application-Id }
[ Result-Code ]
[ Experimental-Result ]
{ Auth-Session-State }
{ Origin-Host }
{ Origin-Realm }
*[ Supported-Features ]
[ Wildcarded-Public-Identity ]
[ Wildcarded-IMPU ]
[ User-Data ]
*[ AVP ]
*[ Failed-AVP ]
*[ Proxy-Info ]
*[ Route-Record ]

The User-Data AVP is extended to include the user type information element as described further.

Subscribe-Notifications-Answer (SNA)
< Subscribe-Notifications-Answer > ::=< Diameter Header: 308, PXY,
16777217 >

< Session-Id >
{ Vendor-Specific-Application-Id }
{ Auth-Session-State }
[ Result-Code ]
[ Experimental-Result ]
{ Origin-Host }
{ Origin-Realm }
[ Wildcarded-Public-Identity ]
[ Wildcarded-IMPU ]
*[ Supported-Features ]
[ User-Data ]
[ Expiry-Time ]
*[ AVP ]
*[ Failed-AVP ]
*[ Proxy-Info ]
*[ Route-Record ]

The User-Data AVP is extended to include the user type information element as described further.

Push-Notification-Request (PNR)
< Push-Notification-Request > ::=< Diameter Header: 309, REQ, PXY,
16777217 >

< Session-Id >
{ Vendor-Specific-Application-Id }
{ Auth-Session-State }
{ Origin-Host }
{ Origin-Realm }
{ Destination-Host }
{ Destination-Realm }
*[ Supported-Features ]
{ User-Identity }
[ Wildcarded-Public-Identity ]
[ Wildcarded-IMPU ]
[User-Type]
[ User-Name ]
{ User-Data }
*[ AVP ]
*[ Proxy-Info ]
*[ Route-Record ]

The User-Type AVP is new, and contains an integer to indicate the type of user affected. The simple presence of this AVP will instruct the AS to perform a batch/massive update of the data changed (e.g. IMS registration status) for users affected. Since this is a request affecting more than user, the User-Identity AVP is not applicable, but it is still mandatory in the diameter command (for backward compatibility reasons), so it may contain any identity. Note that AS application layer, upon reception of User-Type AVP, will not take into account the User-Identity AVP.

Impact on XML Schema (User-Data AVP)

The XML sheet containing the user data is extended so that User-Type is included as shown below (only the relevant part of XML is shown for simplicity).

```
<xs:complexType name=“tShIMSDataExtension5”>
<xs:sequence>
<xs:element name=“ReferenceLocationInformation” type=
“tReferenceLocationInformation” minOccurs=“0”
maxOccurs=“unbounded”/>
<xs:element name=“Extension” type=“ tShIMSDataExtension6”
minOccurs=“0”/>
</xs:sequence>
</xs:complexType>
<xs:complexType name=“ tShIMSDataExtension6”>
<xs:sequence>
<xs:element name=“UserType” type=“tUserType” minOccurs=“0”
maxOccurs=“1”/>
<xs:element name=“Extension” type=“ tExtension”
minOccurs=“0”/></xs:sequence>
</xs:complexType>
<xs:simpleType name=“ tUserType ” final=“list restriction”>
<xs:restriction base=“xs:int”>
<xs:minInclusive value=“1”/>
<xs:maxInclusive value=“65535”/>
  </xs:restriction>
  </xs:simpleType>
```

New Sh Feature (Supported-Features AVP)

The feature list is extended with the new feature to be advertised by the AS. A new bit (4) in the bitmask is used for this purpose.

| | | | |
|---|---|---|---|
| 4 | Batch_proc | O | Batch procedures indication |
| | | | This feature is applicable for the UDR/UDA, |
| | | | PNR/PNA and SNR/SNA command pairs. |
| | | | If the AS supports the feature, the HSS may |
| | | | send a single request (PNR) to perform |
| | | | massive notitications. |

Accordingly, solutions have been described that comprise a new attribute/parameter to be provided to the S-CSCF and the AS over Cx and Sh interfaces, respectively, which may optionally be accompanied by some extra optional filtering, such as a range of telephone numbers, or public identities in the form of a regular expression. The attribute indicates the type of user in terms of services, core network authorization, capabilities required, or any other aspect that the operator may consider (e.g. user geographical location). The primary focus was placed on the Cx details, but the skilled person understands that the same approach is taken for Sh interface. That is, the User-Data XML schema exchanged over Sh is extended to include the new information element when the AS requests certain data (e.g. IMS user state and location).

In brief, an exemplary embodiment of a solution comprises storing new data in the HSS in respect to individually, each and every of the users that share at least a certain aspect of a service profile (referred here as “user-type”). For example, initial registration of an UE comprises that the HSS downloads to the assigned S-CSCF (via the “Cx” interface), together with the corresponding profile data, a new information element/AVP called “user type” (or at least its value) whose value correspond to the downloaded profile. The user type value is stored by the S-CSCF in relationship with identifiers of the UE and/or concerned user. Further, when an update of service profile(s) is made (e.g. via O&M) in the HSS, the HSS sends to the corresponding S-CSCFs, instead of one signal per affected UE/user comprising all the service profile data, one single signal comprising: the “user type” of the UEs/users affected by the update, together with the corresponding, i.e. updated, service profile data.

According to the above discussion, massive signaling in the core network for both Cx and Sh interfaces is avoided. Further, massive signaling in the access network (Gm/Gi/sGi interfaces) for network initiated de-registration is avoided, since the users are informed about de-registration at the first traffic activity.

Furthermore, the above scheme allows an immediate profile update or de-registration, since it only depends on a single node to replace/remove the profiles and it can be done at the first traffic activity received for the user. Additionally, it allows IMS users' classification depending on the network topology/services offered, etc. for some other purposes, such as statistics (e.g. the operator might be able to check the registered users of a certain type if the counters are keyed using the user type). Moreover, it helps to develop implementation specific procedures at each node (e.g. CSCF may offer an O&M procedure to perform a network initiated re-authentication for certain users).

It must be noted that the solution proposed can be more flexible if optional IEs are added to the User Type IE, that is, a wildcarded identity can be added to the Cx-RTR to de-register users of a certain type and number series range or subdomain (e.g. tel: +3491!.*!, sip:!.*!@bstk.telefonica.net).

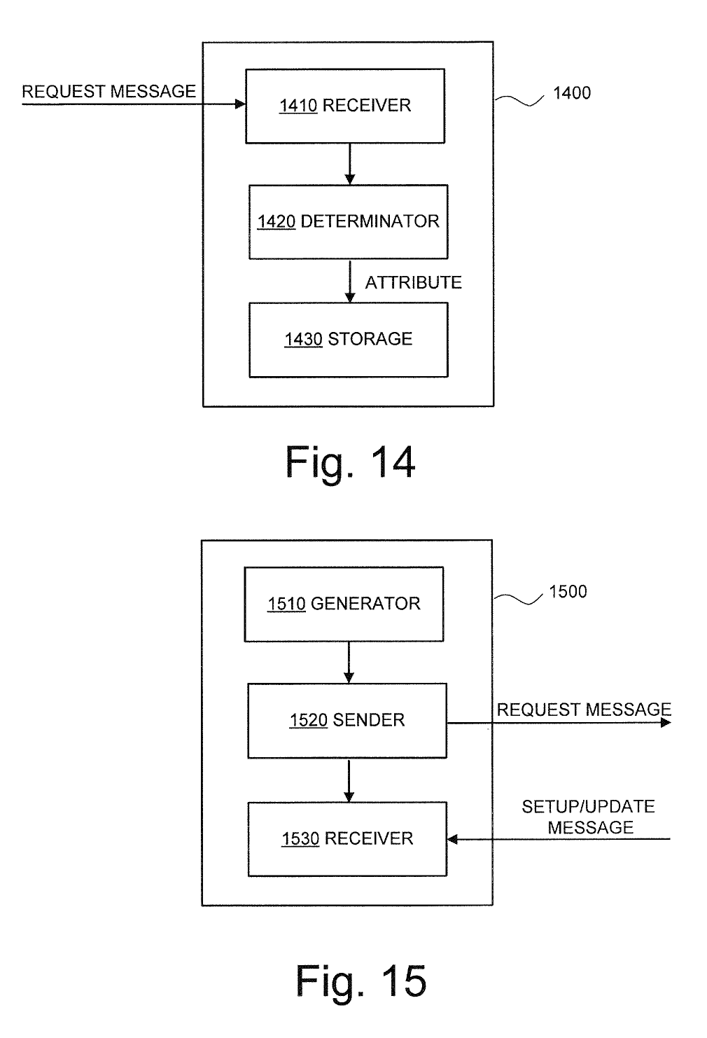

In the following, the nodes illustrated in FIGS. 14 and 15 are explained, which carry out operations which were discussed above.

FIG. 14 is a schematic diagram of an exemplary implementation of a subscriber information node 1400, which may for instance be a HSS. As illustrated, the node 1400 includes a receiver 1410, determinator 1420 and storage 1430. As shown, the receiver 1410 is configured to receive a request message identifying a user and the determinator 1420 determines whether the received request message comprises an indication of support of a user type associated with the user. The node further comprises a storage 1430 configured to store for the user an attribute associated with the user type if the received request message comprises the indication of support of the user type. For the detailed functions/operations of the node and its elements it is referred to the discussion with respect to FIG. 3.

FIG. 15 is a schematic diagram of an exemplary implementation of another node 1500, e.g. a system node including a call session control function or application server function. The node comprises the generator 1510 configured to generate a request message identifying a user. The node further comprises the sender 1520 configure to send the generated request message to a subscriber information node and the receiver 1530 configured to receive from said subscriber information node a profile downloading message and/or an update profile message, which have been described below. For the detailed functions and operations of the node and its elements it is referred to the discussion with respect to FIG. 4.

It should be understood that the elements of the nodes are functional elements and its functions may be distributed differently, for example they may be carried out by a processing unit in connection with other components. That is, the nodes may also be constituted by a bus, a processing unit, a main memory, a ROM, a storage device, an I/O interface consisting of an input device and an output device, and a communication interface. The bus may include a path that permits communication among the components of the node.

The processing unit may include a processor, a microprocessor, or processing logic that may interpret and execute instructions, such as the above-described operations/steps. Main memory may include a RAM or another type of dynamic storage device that may store information and instructions for execution by processing unit. For example, the determinator 1420 and generator 1510 may be realized by a processing unit. The ROM may include a ROM device or another type of static storage device that may store static information and instructions for use by the processing unit. Storage device may include a magnetic and/or optical recording medium and its corresponding drive and may provide the functions of the storage 1430.

The input device may include a mechanism that permits receiving messages from another node, and may provide functions of the receiver 1410 or receiver 1530. The output device may include a mechanism that outputs information, such as messages and may provide functions of the sender 1520. The communication interface may include any transceiver-like mechanism that enables the node communicate with other nodes.

A node as constituted above may perform certain operations or processes described herein, i.e. perform operations in response to the processing unit executing software instructions contained in a computer-readable medium, such as main memory, ROM, and/or storage device. A computer-readable medium may be defined as a physical or a logical memory device. For example, a logical memory device may include memory space within a single physical memory device or distributed across multiple physical memory devices. Each of the main memory, ROM and storage device may include computer-readable media with instructions as program code. The magnetic and/or optical recording media (e.g., readable CDs or DVDs) of the storage device may also include computer-readable media. The software instructions may be read into the main memory from another computer-readable medium, such as the storage device, or from another device via the communication interface. The software instructions may cause the processing unit including a data processor, when executed on the processing unit, to cause the data processor to perform operations or processes described herein. Alternatively, hardwired circuitry may be used in place of or in combination with software instructions to implement processes and/or operations described herein. Thus, implementations described herein are not limited to any specific combination of hardware and software.

The physical entities according to the different embodiments of the invention, including the elements, nodes and systems, may comprise or store computer programs including software instructions such that, when the computer programs are executed on the physical entities, steps and operations according to the embodiments of the invention are carried out, i.e. cause data processing means to carry out the operations. In particular, embodiments of the invention also relate to computer programs for carrying out the operations/steps according to the embodiments of the invention, and to any computer-readable medium storing the computer programs for carrying out the above-mentioned methods.

Where the terms receiver, determinator, sender, generator and storage are used, no restriction is made regarding how distributed these elements may be and regarding how gathered these elements may be. That is, the constituent elements of the nodes and systems may be distributed in different software and hardware components or other devices for bringing about the intended function. A plurality of distinct elements may also be gathered for providing the intended functionalities. For example, the elements/functions of the node may be realized by a microprocessor and a memory, wherein the microprocessor may be programmed such that the above-mentioned operations, which may be stored as instructions in the memory, are carried out.

Further, the elements of the nodes or systems may be implemented in hardware, software, Field Programmable Gate Arrays (FPGAs), Application Specific Integrated Circuits (ASICs), firmware or the like.

It will be apparent to those skilled in the art that various modifications and variations can be made in the entities and methods of this invention as well as in the construction of this invention without departing from the scope of spirit of the invention.

The invention has been described in relation to particular embodiments and examples which are intended in all aspects to be illustrative rather than, restrictive. Those skilled in the art will appreciate that many different combinations of hardware, software and/or firmware will be suitable for practising the present invention.

Moreover, other implementations of the invention will be apparent to those skilled in the art from consideration of the specification and practice of the invention disclosed herein. It is intended that the specification and the examples be considered as exemplary only, wherein abbreviations used in the above examples are listed below. To this end, it is to be understood that inventive aspects lie in less than all features of a single foregoing disclosed implementation or configuration. Thus, the true scope and spirit of the invention is indicated by the following claims.

### ABBREVIATIONS

3GPP 3rd. Generation Partnership Project

AS Application Server (e.g. a SIP application server, or a Open Service Access—OSA—Services Capability Server—SCS—).

CSCF Call Session Control Function (can implement different roles: I-CSCF “interrogating”, P-CSCF “proxy”, and S-CSCF “serving”).

FQDN Full Qualified Domain Name

HSS Home Subscriber Server

IE Information Element (a piece of data included in a message)

SIP Session Initiation Protocol

UE User Equipment (user terminal).

iFC Initial Filter Criteria. Set of conditions to involve Application Servers in SIP requests

IMS Internet Protocol—IP—Multimedia Subsystem

1. A method carried out by a subscriber information node for storing subscription-related information of users in an IP Multimedia Subsystem, IMS, the method comprising:
receiving a request message identifying a user;
determining whether the received request message comprises an indication of support of a user type associated with the user, the user type indicating that the user shares a certain user profile with other users; and
storing for the user an attribute associated with the user type, which attribute is common for a plurality of users all associated with the same user type, if the received request message comprises the indication of support of the user type.

2. The method of claim 1, further comprising sending to a second node including one of a call session control function and an application server function a profile downloading message comprising information on the user type of a user profile stored at the subscriber information node for the user.

3. The method of claim 1, wherein the request message is received from a second node including one of a call session control function and an application server function, and the subscriber information node stores an identification of the second node, if the request message sent by the second node comprises an indication of support of the user type.

4. The method of claim 1, wherein the determining step comprises checking whether a bit for indicating support of a user type is set in a field of a bitmask included in the request message.

5. The method of claim 1, further comprising adding a user to a list of users if the request message identifying the user does not comprise an indication of support of a user type.

6. The method of claim 5, further comprising sending individual update request messages for each user on the list to at least one second node including one of a call session control function and an application server function to update a user profile of each of the users on the list individually.

7. The method of claim 1, further comprising sending to a second node including one of a call session control function and an application server function an update profile message comprising information on the user type stored at the subscriber information node to request to update at the second node the user profiles of the plurality of users associated with this user type.

8. The method of claim 5, further comprising the step of de-registering the users on the list individually by sending individual de-register request messages for each user on the list to at least one second node including one of a call session control function and an application server function.

9. The method of claim 1, further comprising sending to a second node including one of a call session control function and an application server function a de-register message comprising information on a user type stored at the subscriber information node to request to de-register at the second node the users associated with this user type.

10. A method carried out by a node including one of a call session control function and an application server function in an IP Multimedia Subsystem, IMS, the method comprising:
generating a request message identifying a user, the request message comprising an indication of support of a user type associated with the user, the user type indicating that the user shares a certain user profile with other users;
sending the generated request message to a subscriber information node; and
receiving from the subscriber information node at least one of:
a profile downloading message comprising information on the user type of a user profile for the user; and
an update profile message comprising information on a user type of user profiles of a plurality of users.

11. The method of claim 10, further comprising storing at least the information on the user type, if the generated request message indicated that the user type is supported.

12. The method of claim 10, further comprising in response to receiving the update profile message, updating user profiles of the plurality of users associated with the user type informed by the update profile message.

13. The method of claim 10, wherein the profile downloading message comprises, as the information on the user type, a user profile including the user type of the user associated with the request message and wherein the update profile message comprises, as the information on the user type, a new user profile and a user type for all users associated with the user type.

14. The method of claim 13, wherein a user profile is a user profile of IMS subscription data and the user profile includes a field indicating the user type.

15. A subscriber information node for storing subscription-related information of users in an IP Multimedia Subsystem, IMS, the subscriber information node comprising:
a receiver configured to receive a request message identifying a user;
a determinator configured to determine whether the received request message comprises an indication of support of a user type associated with the user, the user type indicating that the user shares a certain user profile with other users; and
a storage configured to store for the user an attribute associated with the user type, which attribute is common for a plurality of users all associated with the same user type, if the received request message comprises the indication of support of the user type.

16. A node including one of a call session control function and an application server function in an IP Multimedia Subsystem, IMS, the node comprising:
a generator configured to generate a request message identifying a user, the request message comprising an indication of support of a user type associated with the user, the user type indicating that the user shares a certain user profile with other users;
a sender configured to send the generated request message to a subscriber information node; and
a receiver configured to receive from said subscriber information node at least one of:
a profile downloading message comprising information on the user type of a user profile for the user:, and
an update profile message comprising information on a user type of user profiles of a plurality of users.

17. A system comprising:
a subscriber information node for storing subscription-related information of users in an IP Multimedia Subsystem, IMS, the subscriber information node comprising:
a receiver configured to receive a request message identifying a user;
a determinator configured to determine whether the received request message comprises an indication of support of a user type associated with the user, the user type indicating that the user shares a certain user profile with other users; and
a storage configured to store for the user an attribute associated with the user type, which attribute is common for a plurality of users all associated with the same user type, if the received request message comprises the indication of support of the user type; and.
a node including one of a call session control function and an application server function in an IP Multimedia Subsystem, IMS, the node comprising:
a generator configured to generate a request message identifying a user, the request message comprising an indication of support of a user type associated with the user, the user type indicating that the user shares a certain user profile with other users;
a sender configured to send the generated request message to a subscriber information node; and
a receiver configured to receive from said subscriber information node at least one of:
a profile downloading message comprising information on the user type of a user profile for the user; and
an update profile message comprising information on a user type of user profiles of a plurality of users.

18. A computer storage medium storing a computer program including instructions that, when executed on a data processor of a subscriber information node, cause the data processor to execute a method carried out by the subscriber information node for storing subscription-related information of users in an IP Multimedia Subsystem, IMS, the method comprising:
receiving a request message identifying a user;
determining whether the received request message comprises an indication of support of a user type associated with the user, the user type indicating that the user shares a certain user profile with other users; and
storing for the user an attribute associated with the user type, which attribute is common for a plurality of users all associated with the same user type, if the received request message comprises the indication of support of the user type.

19. The method of claim 2, wherein the profile downloading message comprises, as the information on the user type, a user profile including the user type of the user associated with the request message.

20. The method of claim 11, wherein the profile downloading message comprises, as the information on the user type, a user profile including the user type of the user associated with the request message and wherein the update profile message comprises, as the information on the user type, a new user profile and a user type for all users associated with the user type.
